(19) United States
(12) Patent Application Publication
(10) Pub. No.: US 2006/0173974 A1
(43) Pub. Date: Aug. 3, 2006

(54) System and method for providing mobile access to personal media

(76) Inventor: Victor Tang, Los Altos, CA (US)

Correspondence Address: WEIDE & MILLER, LTD., 7251 W. LAKE MEAD BLVD., SUITE 530, LAS VEGAS, NV, 89128, US

(21) Appl. No.: 11/344,720

(22) Filed: Feb. 1, 2006

Related U.S. Application Data
(60) Provisional application No. 60/648,694, filed on Feb. 2, 2005.
(60) Provisional application No. 60/655,888, filed on Feb. 25, 2005.

(51) Int. Cl. G06F 15/16; G06F 15/173

(52) U.S. Cl. 709/217; 709/225

(57) ABSTRACT

The invention is a media access system. A multipoint installation may create a connection system which permits client devices, such as wireless media playback devices, to connect to host devices in a partnered relationship which permits authorized access to selected media located on the host device, without a need to physically synchronize the partnered client devices. Playback of media content may be configured on a variety of devices where new media content may be offered for purchase. Furthermore, the system permits authorized storage of additional selected media on the host devices. A personalized music radio for receiving personalized music services is also described. Media accessed may be tracked and stored along with user preferences in a personalization engine.

### 1. CROSS-REFERENCE TO RELATED APPLICATIONS

This Application claims priority to U.S. Provisional Application No. 60/648,694, filed Feb. 2, 2005, and U.S. Provisional Application No. 60/655,888, filed Feb. 25, 2005, both entitled: System and Method for Wireless Personal Mobile Media and both in the name of the same Applicant.

### 2. FIELD OF THE INVENTION

The invention relates to methods and systems for accessing media and more particularly to improved systems and methods for remotely accessing designated privately held media such as audio and video.

### 3. RELATED ART

Currently, a number of devices and systems exist for accessing and presenting media such as audio (such as music), images or video. These devices and system suffer from a number of drawbacks, especially when considering an individual's desire to access the media from a number of locations at any time.

Currently, some cell phones (hereinafter denoted devices) are configured to present media. In one configuration, media may be stored directly at the device for later access and presentation. This may require that the device be modified to include a substantial amount of storage memory, such as one or more flash drives or hard-drives, to support storage of the desired media. Additionally, media playback capability and functionality may need to be added to the device, as well as a means to physically synchronize the desired media between a remote location and the storage memory of the device.

In another configuration, media may be continually transmitted to the device. In one system, a portable device such as a cell phone may access server-based streaming radio from providers such as ShoutCast® (available from Nullsoft, Inc., USA) or Rhapsody® (available from RealNetworks, Inc., USA). In this system, the media is not continually stored at the portable device, so that if the connection to the server is lost, media presentation stops. Additionally, this system only provides access to externally programmed “radio stations” and does not provide an individual with the option to select individual songs.

In another system, media is transmitted from satellites. In one system called XM® satellite radio, streaming media is transmitted from a satellite may be accessed using a special XM® radio player. Currently, XM® satellite radio service has not yet been incorporated into a cell phone, requiring an individual to carry both a cell phone and a separate special music player in order to have both telephone and music playback capabilities. This system also again only provides pre-programmed radio stations rather than individual selected music, and music playback ceases if a connection with the service is lost.

In yet another system called GotoMyPC® (available from Citrix Systems, Inc., USA), a special connection proxy may be used to access a host device and retrieve music files wirelessly. This system does not provide streaming music playback and is usually implemented via a Web client. In this system both download and playback functions require separate actions initiated via separate programs.

In general, existing systems for accessing media have various disadvantages. One disadvantage is that a user may need to obtain and transport a device for media access and playback, which device is unique and separate from other devices which provide other desired functionality, such as a cellular telephone. For example, an individual may carry a cell phone for communications but may also carry a separate portable media player for media playback.

A disadvantage of devices which store the media relates to device memory constraints. The memory of a portable music player is limited. A user must select particular music to associate with their music playback device. That media is normally associated with the device by downloading the media to the portable device from a personal computer (PC). Generally, a user must also be physically at the same location as the player and the personal computer in order to perform the downloading task. Because the capability to store media is limited, an individual generally can not download all desired media to their player. The individual may thus find that when they wish to access particular media (such as when traveling and remote from their computer), it is not currently stored on their player.

It is likely that this issue will become more acute with video player devices that are now appearing in the marketplace. Video file sizes are significantly larger than those of music files, so the device (or player) needs an even larger hard drive (or memory storage), which in turn may drive up the size and cost of the device. Alternatively, individuals will be very limited in the number of files they can associate with their device, making it more likely that a particular video is not associated with their device when the individual wishes to view it.

Yet another disadvantage of existing systems and devices relate to how tedious it is to associate new media with a portable player. Generally, the user view video on a television or listens to songs on the radio, or music or video is recommended to the user by another party. Devices which only present streaming media do not permit the user to personally possess and present the media on demand. Relative to those devices which are capable of storing and presenting the media on demand, the user must both acquire the media and load it onto the user's PC. Next, the user must either associate the media with their media player library and synchronize that library with the memory of their device, or specifically download that media from their computer to the memory of their portable device.

Further, in the above-described scenario, the user must associate the media with their own computer. If the media is initially associated with a third party's computer or personal device, additional steps must be taken to transfer the media. Often, this is difficult. For example, the media may be transferred via an FTP-server, a mailbox that supports the sending and receiving of particularly large files (which is uncommon due to various limitations), by intermediately storing the media, such as on a CD, DVD or other portable data storage device such as a flash-memory device.

It is also not always easy to obtain the desired media from a commercial source. For example, if the user hears a song but can not identify its title, the user must find someone to recognize and identify the song title while the song is playing. In all practicality this is often difficult to accomplish. Even if the song is identified, the user must then still find a commercial source offering that song in the desired media format.

Another disadvantage of current systems and devices is that the user is generally limited to listening to a radio for new/different music or using a media player to listen to their own collection. A better situation would be to have a portable music player that functions as a radio, blending music from the user's personal collection with new content custom-tailored to the user's preferences and listening habits.

Currently, it is also not possible to show recently created digital pictures to third parties in the event the user does not already have the digital pictures loaded on the user's camera or phone or to a third-party accessible server which is associated with the Internet. It would be desirable to allow users to access their entire picture collection and navigate and view this collection on demand, including from remote locations and using portable devices.

Apart from the above-described media there is a huge selection of online media available via peer-to-peer services or online stores, but such media is not accessible when a user is away from the user's computer. For example, access to online media would be useful when driving, working out, and riding public transport such as a bus, subway or train.

### SUMMARY

In an embodiment of the invention, a connection system is disclosed. The system comprises, in combination, at least one host device configured with at least a first portion of a connector application package with the at least one host device in communication with at least one client device configured with at least a second portion of the connector application package. The connector application package facilitates authorized access of media on the at least one host device by the at least one client device, wherein the media comprises at least one of media residing on the at least one host device and additional media to be stored on the at least one host device or at least one server.

The system further comprises at least one server, the at least a first portion of the connector application package of the at least one host device being configured to maintain communication with the at least one server and to invite at least one identified client device configured with at least a second portion of the connector application package to connect to the at least one host device. At least one server is provisioned with at least identifying data associated with the at least one host device to protect and authorize communication between the at least one host device having a firewall and the at least one client device.

The client device comprises at least one authorized wireless device configured to access at least one media player to play the media on the at least one host device. The system may further comprise at least one preference engine configured to track accessible media and to apply a weighting to the accessible media based on how often the accessible media is accessed.

In one embodiment, the at least one client device comprises a remote control in communication with at least one media player application, the remote control being s configured to instruct the at least one media player application to playback the media on at least one authorized host device. The at least one media player application comprises at least one cache to allow playback of media to continue when communication between the at least one host device and the at least one client device is momentarily lost.

In another embodiment of the invention, a personalized radio is disclosed. The radio comprises, in combination, a client device configured with at least a first portion of a connector application package, at least one host device configured with at least a second portion of the connector application package and the host device in communication with the client device. The connector application package facilitates authorized access of distributed media on the personalized radio comprising at least one of the at least one host device and the client device, wherein the distributed media comprises at least one of media residing on the at least one host device and additional distributed media to be stored on the at least one host device or at least one server.

In yet another embodiment of the invention a method of installing and implementing a connection system is disclosed. The method comprises providing at least one host device and at least one client device; configuring the at least one host device with a first portion of a connector application package to create at least one user account data; configuring the at least one client device with a second portion of the connector application package to thereby communicate with the at least one host device; and facilitating authorized access of media with the connector application on the at least one host device by the at least one client device, wherein the media comprises at least one of media residing on the at least host device and additional media to be stored on the at least one host device or at least one server.

The method further comprises storing the at least one user account data on at least one server; and maintaining a connection between the at least one server and both the at least one host device and the at least one client device to permit accessibility of the media. In further steps the method comprises installing at least one host application on the host device; coupling the at least one host application to at least one pre-existing host application; and generating a host device token, the host device token stored on the at least one server to prevent unauthorized access to the at least one host device.

The method further comprises entering at least one client identifier corresponding to the at least one client device to configure the at least one client device with the second portion of the connector application package; binding a communication connection of the at least one client device to a communication connection of the at least one host device; and streaming media between the at least one host device and the at least one client device

The method further comprises storing streamed media transferred from the host device to the client device onto the client storage memory either in whole, or buffering (caching) a small subset prior to playback. Stored media may subsequently be played on the client device, even when a communication connection with the host device cannot be established.

The method further comprises the automation of media downloading from the host device to the client device performed by the client application. Such downloading is based on user preference such as frequency of download, type of content, percentage of storage memory to refresh, as well as other factors such as availability and cost of one or more networks.

Installation of the connector package may depend on sending linking messages to installation packages for any partner device. In other words a client device (such as a cell phone or media device) may be a partner device in a desktop device-initiated installation or vice versa. During installation embedded hints (links) may provide shortcuts in the installation software for each partner device, via for example, a unique host (or desktop) token. Such messages may be delivered wirelessly using a cell phone network or via the Internet, combined with installation packages that are downloaded from a website and configuration wizards that simplify the entire provisioning process to facilitate complex three way installations (on a client device such as a cell phone, host device such as a desktop PC and one or more servers). Advantageously, such an installation may require no physical synchronization between partner devices, and each partner device's installation may be completed conveniently (either immediately or several days apart or even by separate individuals). Of course, client-first or host-first installation may occur so that the order of installation is inconsequential. Furthermore, a client installation package configured with a host installation may be preloaded on a wireless device without a need for accompanying material, such as a CD-ROM.

In yet another embodiment, the client application on the client device presents recommendations of new media, not stored at the host device, which a user may elect to purchase. Upon such election, the client application, utilizing the connection with the host application on the host device, may cause the selected media to be purchased and downloaded to the host device, whereupon it is further transferred to the client device.

The method further comprises converting media from a first format on the host device to a second format more advantageous for wireless transfer and storage on the client device, the conversion being automatically performed by a host application.

It will be appreciated that in other embodiments of the invention a client device may have one or more network connections and storage. The client device may have one or more client applications with one or more communication packages. In a preferred embodiment the client device has a unique device identifier. The client device may be a phone, PDA (Personal Device Assistant), media player device, laptop, desktop PC, home or car stereo with networking capabilities, or any other similar device.

Furthermore, a host device may have a network connection and storage and access to media content. The host device may have one or more host applications with one or more communication packages. In a preferred embodiment the host device has a unique host device identifier.

In another embodiment the host application enables, authenticates and/or authorizes connections by one or more client applications to one or more services on the host device enabling the client applications to invoke host services and retrieve content indexes and download the actual content accessible from the host device. The services may be functionally incorporated directly into the host application or provided by additional applications accessible from the host device.

The services provided by one or more host applications or by plug-ins to pre-existing host applications and pre-existing host applications may be started by one or more host applications if not already running.

The services may additionally be provided by new applications installed on host devices. The services may provide functionality such as music purchase and download from one or more online music stores. Furthermore the services may provide transformation functionality to convert media content accessible by one or more host devices from a first format to a second format that is more suitable for wireless transmission or viewing from a client device.

In yet another embodiment, a host application may have a list of one or more authorized client devices, with each authorized client device identified by a unique client identifier. The list may further identify the client device as an owner or a guest, such identification determining which host services are made available to the client device.

In another embodiment the client device has functionality to play, view or otherwise act upon content stored on client device storage and ability to read, store, update and remove content on client device storage.

Furthermore, a client application may have a list of one or more host devices and can establish a connection via the communication package to any host device. Additionally, the client application may retrieve a content list from one or more services on one or more host devices. The client application may display the media content list and permit navigation of that list. In an embodiment a user may select one or more media content from the media content list on the client application and invoke the client application to retrieve the corresponding host media content via the connection with one or more host services made accessible by a host application, the media content being downloaded via the connection and saved in client storage of each of the one or more client devices.

In another embodiment the media content being downloaded and saved may also be buffered so that it can be played and/or viewed as it is still in the process of being downloaded, if so desired by the user. The client application may retrieve content from the content list (synchronize) automatically, without interaction by a user, such that a connection with a host application is made based on certain criteria such as network connection being possible, host device accessibility, user preferences stored on client device, such as preferred networks where multiple network types exists, and time of or interval between automated synchronizations.

In another embodiment, the client application may retrieve media content automatically from the content list. The determination of the media content may be based on user preferences stored on the client device. The preferences may include percentage of storage capacity to utilize, percentage of already downloaded content to replace, type of content (genre, tempo, age, ranking and so on).

In one embodiment, a client installation package comprises a client application, a communication package and a configuration wizard. The installation package may be made available on the client device by various means including but not limited to an SMS message containing a link to a server from which the package can be retrieved. The retrieval may be initiated by a user or automated by an application deployment package preinstalled on the client device. A user may initiate download via a URL to the package on a server and a browser resident on the client application. Synchronization or copying of the package from a desktop PC to the client device may be initiated. The package may be pre-installed on a client device's memory. A downloader application or URL link to a download may be pre-installed on the client device and the user may invoke either the downloader application or the URL link. In further steps of the installation, the client application may include functionality to identify and pair with a host device (a client pairing wizard)

Furthermore, in another embodiment a host installation package may comprise one or more host applications, one or more communication packages, and one or more configuration wizards. The host installation package may further comprise one or more plug-ins, and one or more additional host services. The host application may include functionality to identify and pair with a client device (a host pairing wizard).

In one embodiment of the invention, a method is disclosed whereby the client and host configuration wizard individually may invoke one or more servers to provision the device and establish a globally unique device identifier, which may stored on the respective device and one or more databases associated with the servers.

In one embodiment of the invention, a method is disclosed the unique client or host device identifier may be randomly generated by the client or host application or where the identifier is a globally unique attribute of the device, such as the device phone number or a network MAC address.

Furthermore, in yet another embodiment a method of binding host and client devices may utilize one or more servers wherein the servers are invoked by both client and host pairing wizards and a pairing identifier is generated and displayed on one device. The pairing identifier may be read and manually entered on the other device. The entered identifier may be submitted to servers where it may be compared with the generated pairing identifier and where a match may be determined. The host and client devices may be deemed to be paired by the servers. Unique host and client identifier pairs may be subsequently stored on the servers, host and client devices.

In a further aspect of the method, the generation and entry sequence may be repeated and the entering versus displaying devices switched, to further guarantee the authenticity of the pairing. Public and/or private keys may be generated by either one or more servers or the client and host devices and shared between the devices and the servers.

In yet further aspects of the method authentication data such as user name and password may be retrieved by the host configuration wizard and submitted to one or more servers for storage in one or more databases associated with the servers. Furthermore, the public and/or private keys may be utilized to further authenticate a client application connection to a host application to access host services and content.

In another aspect, the host application may make an outbound connection to one or more servers to allow inbound access to host services from one or more client devices via the servers to facilitate remote access of a server which is not otherwise accessible remotely because of a lack of a static IP address or the presence of a firewall which prevents access.

In one embodiment one or more servers may accept connections from client applications. The servers authenticate the inbound connections from host and client devices, authenticating each one utilizing authentication data such as username, password, public/private keys that was submitted to the servers during device configuration. Upon successful authentication the servers identify each inbound device connection by the device's unique identifier. Upon finding connections from two devices that have been deemed to be paired with such pairing data previously stored in one or more databases associated with the servers in a previous pairing step, the servers bind the two device connections together, such that the client application's connection to the servers flow directly through to the host application's connection to the server. Thus requests made by the client application flows through this bound pair of connections to the host application for fulfillment, with responses going back through this bound connection pair to the client application.

In another aspect, the one or more servers may utilize pairing and authentication data stored on one or more databases associated with the servers, accept and maintain thousands of device connections, rejecting unauthenticated connections, pairing authenticated connections as determined by the pairing data, enabling connections between one or more client devices to individual host devices.

In another embodiment of a device pairing method, the method comprises provisioning functionality on one or more servers by accepting an email address submitted by a client configuration wizard, and generating an email containing client configuration information and/or a host installer package or link to the same e-mail address. Alternately the host installer package or link may be preconfigured with the client configuration information having embedded information therein.

In another aspect of the method, a user at the host device may retrieve the email and retrieve and execute the host installer package from the e-mail. The host configuration wizard may complete the user and host provisioning tasks in conjunction with provisioning functionality on one or more servers and utilize the accompanying client configuration information to complete the binding to the initiating client device. User, host and pairing data may be stored via the servers on one or more databases associated with the servers.

In yet another embodiment of a device pairing method, the method comprises provisioning functionality on one or more servers and accepting a phone number associated with a client device submitted by a host configuration wizard. The servers may subsequently send an SMS message to the phone number, the message containing a link to a client installation package, preconfigured with host device and user account configuration information.

In another aspect of the method, the client installation package may be downloaded and executed and the client configuration wizard in conjunction with the provisioning functionality of one or more servers and utilize the accompanying host configuration and user data to complete the binding to the initiating host device. User, host and pairing data may be stored via the one or more servers on one or more databases associated with the servers.

In another embodiment of the invention the client application may have a remote control functionality whereby actions such as play, next, previous, pause, etc invoked at the client application by the user is transmitted via the client connection to the host application to the host service, invoking said action at the host service, further causing a pre-existing host application to play, skip or otherwise act on content on the host device, as if the user was directly interacting with the host application.

In another embodiment of the invention, a client application may be a web browser connected to one or more servers. In operation a user may enter username and password information to log into a user account and may be presented with a list of host devices associate with a user profile.

The user may select a host device and one or more servers connect to the host device on the user's behalf, retrieving the content indexes to be returned and displayed by the web browser. The user may navigate the content index and select the content to be played. The browser may submit this information to the servers and the requested content from the host device may subsequently be streamed to the web browser.

In another embodiment of the invention, a method where one or more servers record and store user preferences on one or more databases associated with the servers is disclosed. Content indexes from a user's host devices may be stored one the databases and weighted based on criteria such as number of times played, times specifically retrieved, skipped, replayed, time of day content is played, tempo and genre of content played at specific times, and so on.

The method further comprises a client application providing feedback functionality whereby a user may rank the currently playing content (for example from “block” to “love”) and such ranking information may be submitted to the preference tracking functionality on one or more servers to be stored and applied towards the weight information associated with the content on the one or more databases associated with the servers.

In another aspect, preference tracking functionality on one or more servers may generate custom playlists for the client application. The playlists may contain content tailored specifically to the user based on the user's evolving tastes, preferences and listening habits. The user may elect to use this playlist on the client application to automatically retrieve and play user media content.

In yet another aspect, user preferences information (the user profiles) may be compared to identify commonalities between them. Subsequently the servers may identify new media content not owned by a user (accessible from the user's host devices) but which exist in other profiles with similar patterns and may be weighted highly. Hence this currently not owned media content may be deemed to have a high probability of being similarly ranked by the user. Custom playlists may be generated and currently owned content may be mixed with highly ranked “new” media content, resulting in a personalized radio service.

The content from custom playlists may be automatically retrieved by the client application, including new media content where business agreements with content providers may permit. Where such agreements do not exist, new content may be presented as a link or menu option by the client application such that the user can select such content for preview (perhaps by retrieving a song or video “snippet”) or out-right purchase.

Furthermore, new content may be retrieved by the client application, such content may be protected by digital rights management (DRM) which may determine that the media content is for single play only, cannot be copied or even to be deleted after playback. Such DRM constraints may be adhered to by the client application. A “buy now” option may be present by the client application when new media content is played. If a user selects the “buy now” option on the client application, that action may be submitted via the client connection to the host application which invokes the music purchase service on the host device to purchase and download the requested media content. That retrieved media content may be subsequently downloaded from the host device to the client device.

In other embodiments any alternate purchase methodology is contemplated whereby the purchase request originates from the client application and results in content being purchased and downloaded by that one action to the client and host devices. User profiles may be created initially via a web-page by browsing other user profiles and an identifying operation may merge profiles identified as being similar into the user's profile. Additionally, favorite tracks, artists and albums, club and DJ (disk jockey) playlists may be entered or selected and added to the new profile.

In various aspects, an existing profile can be updated in similar manner, and additional server content such as internet radio programming, news, sports and other media can be selected for inclusion into the personal radio playlist at specific times. Such items may appear in the custom playlist as links to third party server media content to be retrieved by the client application.

In yet another aspect, multiple users may log in on a single client device, causing the client application to request a special playlist that is an intersection of the preferences of all logged in users. The client application then may attempt to retrieve such content from the various host devices, including the unbound host devices of the guest users. One or more servers having direct access to the unbound host connection may create a temporary binding to the client device, allowing content from unbound hosts to be retrieved. Such content may be deleted on the client application after playback.

In another embodiment of the invention related media content information may be retrieved from one or more servers along with one or more custom playlists, such that each playlist item has a number of related content links. For instance, media content may have related content information from a same artist, another artist with high statistical correlation, a same soundtrack, and so on. This media content information may be presented as the media content is being played by the client application, such that the user can view the related contextual information and select one or more of the related media content for retrieved from an owned host content, or purchased if not owned.

In another aspect, related non-media commercial links may be included as related information links, possibly ticker-taped along the bottom of the client device (for example, concert ticket sales for bands that correlate to user favorite content, promotions that correlate to user's favorite music genre, sports advertising while user is listening to a sports feed, etc) and presented and be selected by the user. Upon selection, a link associated with the advertising may be invoked and presented in a popup window for the user to review.

In one embodiment of the invention a preference engine may monitor user interaction with commercial or advertising links and may weight this user behavior to further tune the advertising information delivered to the user, so that the advertising may be increasingly relevant to the user and more targeted for a marketer. The preference engine weightings may be data mined to glean demographic information to identify quantity, location and other pertinent information of users to be used for targeted marketing and promotional campaigns.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a schematic flow diagram of a portion of a system for configuring a user host device to permit access to personal media.

FIG. 2 illustrates a schematic flow diagram of a portion of a system for configuring a client device to permit access to personal media associated with the user host device of FIG. 1.

FIG. 3 illustrates a schematic flow diagram of a portion of the system of either FIG. 1 or FIG. 2 to store and maintain user information and to use such information to authorize and pair connections between a client device and a host device.

FIG. 4 illustrates a schematic flow diagram of a Personal Radio Service utilizing a Personalization Engine to track user preferences.

FIG. 5 illustrates a schematic flow diagram of a process to remotely control playing of media from the user host device of FIG. 1 or FIG. 2 to a home stereo.

FIG. 6 illustrates a schematic flow diagram of a process to remotely transfer and playback media from the user host device of FIG. 2 or FIG. 2 to a variety of client devices.

FIG. 7 illustrates exemplary displays of the client device of either FIG. 1 or FIG. 2.

FIG. 8 illustrates a schematic flow diagram of a process where a user interacts with streamed media and advertising to affect future delivery of selected media.

FIG. 9 illustrates a schematic flow diagram of a process where a user creates a user profile and merges one or more pre-existing profiles and associated media into the user profile.

FIG. 10 illustrates a schematic flow diagram of a process where more than one user merges multiple profiles using the Personalization Engine of FIG. 4.

FIG. 11 illustrates an exemplary sample display of a Web-based media player.

FIGS. 12A and 12B illustrate an exemplary method of installing and implementing the system of FIG. 1.

### DETAILED DESCRIPTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

1. Glossary of Terms

The following glossary of terms is provided to aid in defining numerous terms commonly used herein. These definitions should not be considered as all-encompassing or limiting, but are intended to provide a point of general reference or meaning.

Media/Media Content: images (such as pictures or graphics), audio or sound (such as music or audio-books), mixed media including one or more of images and/or sound (such as music videos, television shows, sports clips, movies, etc.), regardless of their form or format (such as represented by one or more data files of various formats now known or later developed).

Firewall: network isolation hardware and/or software used to prevent unauthorized access to computers behind or outside of the firewall.

Connection Manager: a device, such as a server, which is associated with a communication network such as the Internet, which device acts as an intermediary between a first device, such as desktop computer, and a second device, such as another computer, phone or PDA, and preferably having as one purpose allowing a firewalled, or otherwise non-addressable first device to be accessible from a wide-area network (WAN). Firewalls by nature prevent devices located behind them to be inaccessible externally. Similarly, devices without a fixed external address are inaccessible. A Connection Manager functions to make such devices accessible.

Host/Host Device: A device which is capable of storing media. The host device may preferably comprise a computing device such as a desktop or laptop computer (or other suitably configured storage device) with communication capabilities and capable of executing computer readable code (such as with an operating system). Such a device may include various components and be configured in various fashions, such as including one or more displays, data storage devices such as RAM, ROM, hard drives, disc drives and data storage devices with removable media such as tapes, compact discs and the like, communication devices such as modems and routers, one or more processors, and the like as is well understood in the art.

Client Device: A device which is capable of receiving and presenting media. The client device may preferably comprise a portable or mobile media presentation device having wireless communication capabilities, such as a cell phone or personal data assistant, and having media presentation or playback capabilities. The client device may also comprise a media player may also comprise a purpose-built media player with a wireless connection. The client device may support a network communication connection permitting reception and presentation of streaming media, such as the Treo™]device using PocketTunes™ available from Palm, Inc., USA. The client device might also be incorporated into or comprise another device which is modified, such as a traditional radio (such as an automobile radio or home stereo) that is provided with a wireless communication link providing access via a client application to a private media, and including a client application user interface (or API) which may be displayed on a screen coupled to the radio.

Playlist—a file containing a sequence of music files to be played, which may contain music of similar era, genre, etc.

iTunes®—A music cataloging and playback application program available from Apple Computer, Inc., USA, often used in conjunction with MP3s and MP3 players such as the iPod®.

iPhoto®—A photo cataloging application from Apple Computer Apple Computer, Inc., USA, for sorting and viewing digital images.

Windows Media® Player—Software from Microsoft Corp., USA to catalog and play audio and video content.

SMS (abbreviation for Short Message Service)—a two-way communication service allowing messages to be sent to and from a cell phone. The SMS message may contain content on a phone-based application to permit access to a server based computer through an associated URL. With such access, an installation or configuration package may be delivered to a device.

Teleservice message—a message sent to a phone via a Teleservice port or ID. The Teleservice message is similar to a SMS message (see above) and may be pushed out to a phone to be received by an application listening on the specific Teleservice port or ID.

Wireless network, 3G (third generation development of a broadband data network using cellular wireless communication). Two examples include Edge/GPRS (enhanced General Packet Radio Service) or 1×RTT (1 times radio transmission technology) over CDMA (code division multiple access multiplexing technology). S Wireless network may also comprise of but is not limited to Bluetooth or variants of IEEE 802.11 protocols.

J2ME—a Java-based development framework for phone-based devices. It comes with streaming APIs (Application Programming Interfaces) to permit access to streaming media from websites such as Shoutcast (standard radio). It also comes with an Internet provisioning and SMS/Teleservice ID listening APIs facilitating much of the work that needs to be done to create a Client Application.

BREW® (Binary Runtime Environment for Wireless)—a wireless phone OS (Operating System) and development platform available from Qualcomm, Inc., USA.

Buffering—read-ahead (or preload) buffering and caching techniques which permits songs to be downloaded before they need to be played and stored, such that a media player is able to play them from memory without being interrupted by a loss of wireless data connection. A small preload buffer eliminates the playback disruption from short connection losses whereas a large cache of preloaded songs allows media to be played for hours without requiring a network connection.

2. System Description

In general terms, one embodiment of the invention is a media connection or access system in which a client device, preferably comprising a mobile media presentation device, may access media from a variety of sources, preferably wirelessly, and in an automated, comprehensive and yet easy-to-use fashion. According to one or more features of this system, a service (or client application or client package) may be created so that media may be accessed via one or more client devices without any limitation on the size or location of the media.

In one embodiment, it is contemplated that the client device is a mobile media presentation device which has a small form-factor and is multi-functional, making the mobile device advantageous to use because it is easy to transport and use and eliminates the need for the user to carry other devices.

According to another embodiment of the system, users may access personalized playlists and interact with the client application. Users' actions may be monitored and utilized to personalize content which may be delivered in the future (as future content) to those users, such as in the form of personalized radio, music videos and wallpapers. Additionally, users may have access to media content sales with their client devices and may transfer purchased media to other devices (such as a user's desktop PC) for more permanent storage of such purchased media. Alternatively, purchased content may be delivered first to the host device and then converted to a preferred format prior to being downloaded to the client device. In yet another embodiment, purchased content may have one format delivered to the client device, with another higher quality format of the same content delivered to the host device.

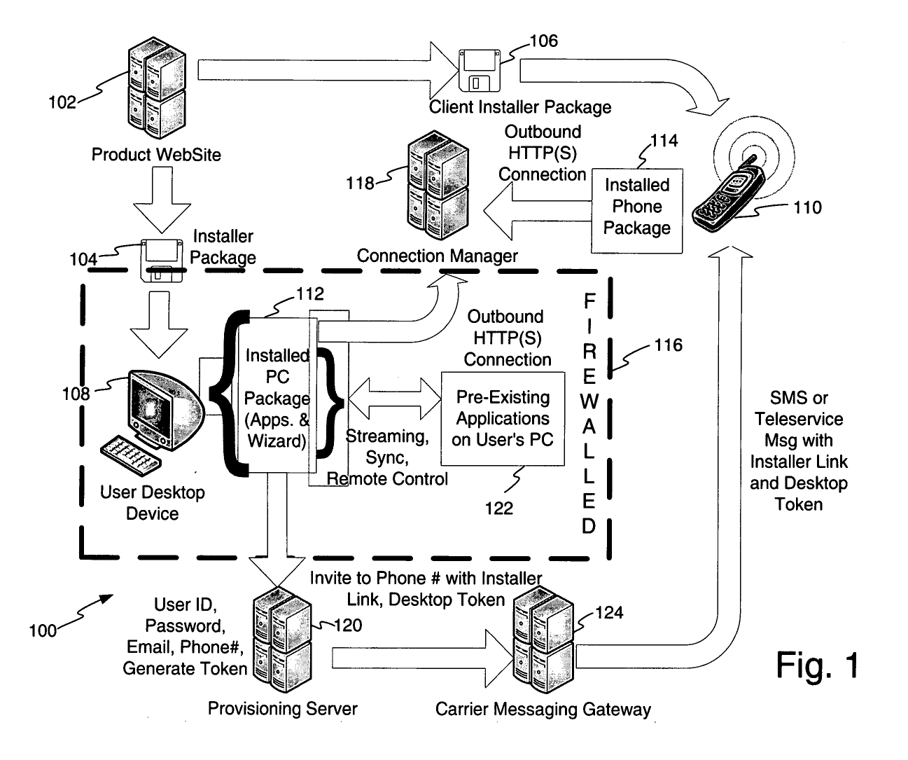

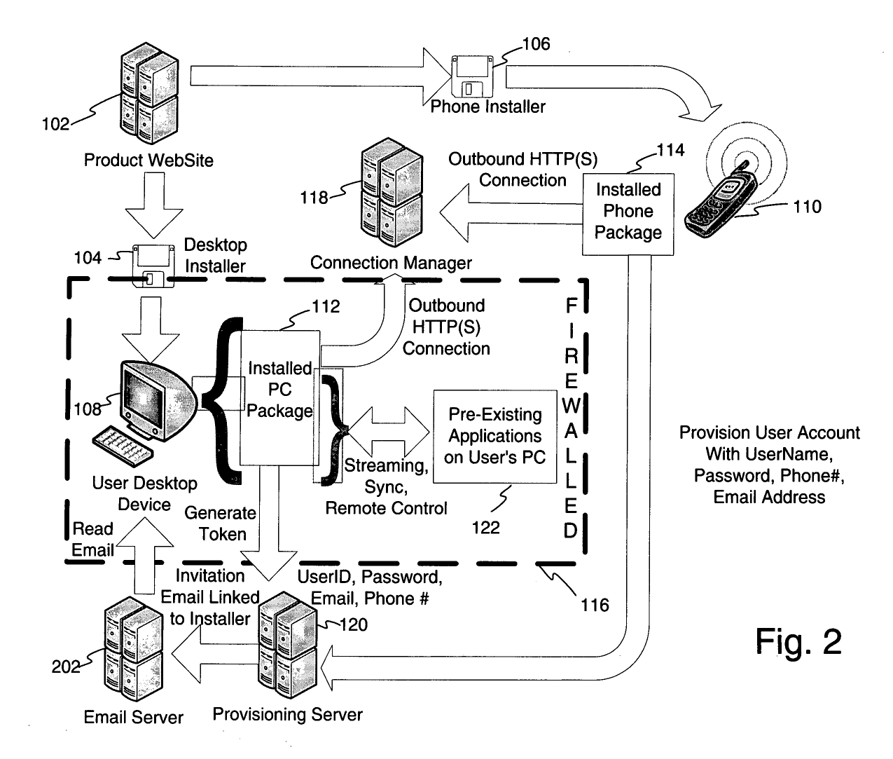

FIG. 1 illustrates a schematic flow diagram of an exemplary embodiment of a portion of a system 100 for configuring a host device 108 (which may comprise a user's desktop computing device, as labeled in FIG. 1) to permit access to personal media, such as via a client device 110. The configuration of another portion of the system 100 may be better understood by further reference to FIG. 2 which illustrates a schematic flow diagram for configuring the client device 110 (which may comprise a cell phone having media playback capabilities, as labeled in FIG. 1) to permit access to personal media on the host 108 of the system illustrated in FIG. 1. In one embodiment, the system 100 comprises one or more components to install a connector application package which, when installed, permits access to a user's personal media (see description below).

As illustrated in both FIGS. 1 and 2, during installation of a connector application package, a product website 102 (or one or more product websites) may comprise a communication link to, and data transfer with, one or more servers or a server based system. Without limiting the scope of the disclosure, the mechanics and components of server based systems are well known by persons skilled in the art.

In one embodiment, the product website 102 preferably provides product marketing information and one or more host installers 104 for the host device 108 (again, depicted in both FIGS. 1 and 2 as a User Desktop Device 108). Furthermore, the product website 102 may provide one or more client device installers 106 for one or more client devices 110 (again, depicted in both FIGS. 1 and 2 as a cell phone).

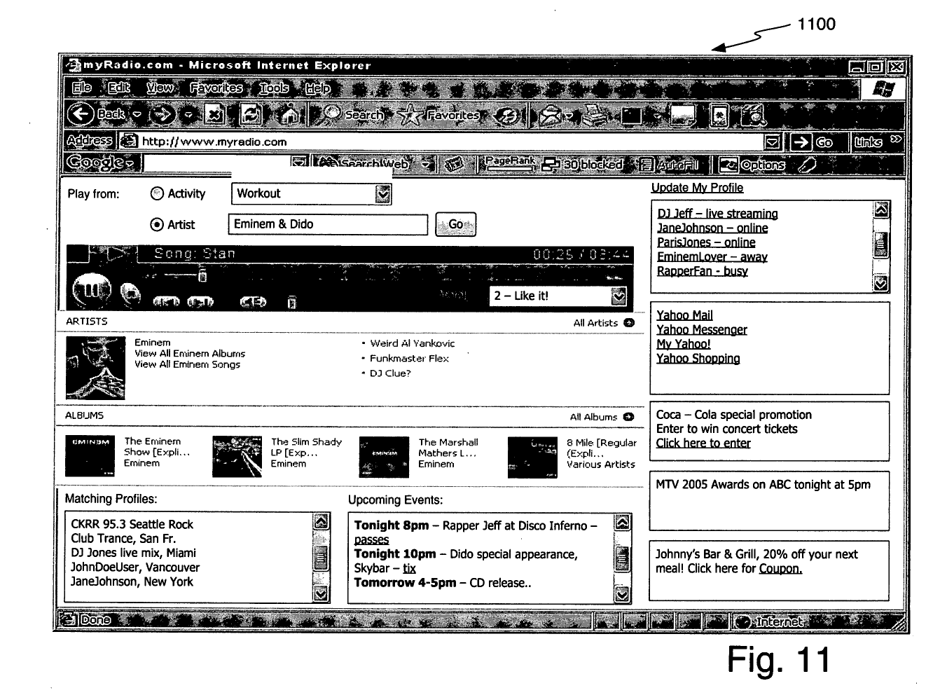

In one embodiment, the product website 102 comprises one or more servers providing one or more of marketing information, a knowledge base, support information and client installation packages suitable for downloading by one or more users of the product website. A browser (not shown in FIGS. 1 and 2, but shown in FIG. 11, see description below) may be used to download installation packages based on information regarding the user device which is to be associated with the system. For example, the type of user device connected to or accessing the product website (e.g. a host device such as a desktop PC or a client device such as a particular mobile media presentation device) may be determined when the website 102 is accessed, automatically (by embedded information submitted (HTTP UserAgent) to the website 102 by the user device) or by manual user input, and in response, an appropriate installation package may be transmitted to the user device. If the type of user device (including operating system (OS) comprising the environment of execution of the installation package and embedded code) is unclear, the user interacting with the product website 102 may be asked to resolve any undetermined information.

The host installers 104 located at the product website 102 create one or more host device installer packages (abbreviated as host application 112 hereinafter, but depicted in FIGS. 1 and 2 as Installed PC Package 112) comprising components installed at the host device 108. The host application 112 may include one or more host device applications, one more host device configuration wizards, one or more media player plug-ins and one or more plug-ins for other applications. Of course, the host device installer packages may comprise one or more programs and sub-programs. It is understood that the host device installers 104 may be associated with removable data storage media or other data storage devices and may be distributed to one or more users to configure one or more host devices 108, rather than by access to the website 102.

The client installers 106 located at the product website 102 create one or more client installed packages 114 (depicted in FIGS. 1 and 2 as Installed Phone Package 114). The client installed packages 114 comprise one,or more components installed on a client device 110.

The client installed packages 114 may include one or more client applications and one or more client configuration wizards, and may make an outbound HTTP or HTTPS or other connection (as is permitted over the networks available to the client device) to a connection manager 118 (depicted in FIGS. 1 and 2 as Connection Manager 118, and see description below). Without limiting the disclosure, HTTP/HTTPS are well known Internet communication protocols. Of course, the client installer packages may comprise one or more programs and sub-programs. In one embodiment, client applications resident on a client device 110 may connect to one or more authorized host devices 108 to access media associated therewith, preferably in streaming format. Client configuration wizards may set up and provision one or more client applications and user accounts on a provisioning server 120 (depicted in FIGS. 1 and 2 as Provisioning Server 120 and see description below). The terms “provision” or “provisioning” are well known by a person skilled in the art and their meaning is better explained in the context of the description of the provisioning server 120 (see below).

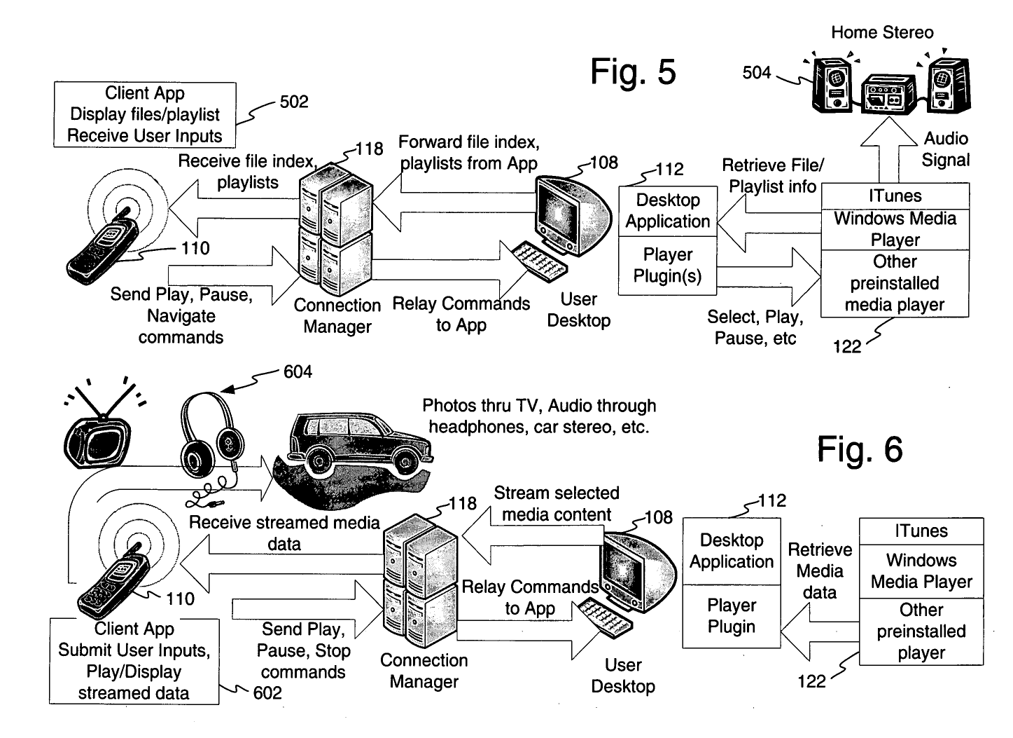

In an exemplary embodiment, a host device 108 includes one or more pre-existing host applications 122 with information (or data), such as one or more media collections. The pre-existing host applications 122 may further comprise one or more pre-installed media players (or media player applications), such as iTunes®, iPhoto®, Windows Media Player, or search engine applications such as Yahoo!® and Google™) and the like. Alternately, the host device installer package 112 could include such an application. The one or more host devices 108 may be protected by a network firewall 116 (depicted in FIGS. 1 and 2 as FIREWALL 116 and in broken lines surrounding the features of the User Desktop Device 108). Additionally the host devices 108 may not have a static IP and thereby may not be addressable remotely. In one embodiment, the host application 112 is configured to reside on a host device 108 to permit external access to the media collection associated therewith, regardless of any firewalls 116, and may connect to a connection manager 118 (see description below and Glossary above) with an outbound HTTP or HTTPS or utilize another available outbound port for connection. As shown in both FIGS. 1 and 2, installed host applications 112 and pre-existing host applications 122 may be seamlessly coupled to provide streaming media without requiring further synchronization, and to further, in another embodiment, provide media by remote control (see further discussion with reference to FIGS. 5, 6 and 10 below).

In one embodiment, depicted in FIG. 1, the provision sequence is initiated at the host device 108, whereby the host application 112 may be retrieved from a product website 102 by any authorized user. Additionally, the host application 112 may automatically self-configure on the host device 108 and send a configuration message to a client device, such as the user's mobile media presentation device, via SMS (see Glossary above) or any other suitable method. In operation, the host application 112 may identify media associated with the host device 108 and attach any portion of the user's media to a pre-existing media player (such as for example iTunes®, iPhoto®, Windows Media Player) with any suitable plug-in module (see further discussion below). In this embodiment, the configuration message in the SMS message provides the information for the client device 110 to retrieve the client installer package 106, or if already installed, to associate that client device with the host device 108.

In another embodiment, depicted in FIG. 2, the provisioning sequence is initiated at the client device 110, whereby the client installer package 106 is loaded onto the client device, whether by manual download by a user from a product website 102, or the package is preinstalled on the client device, or a link to the installer package on a product website is made available to the user on the client device. The client application may automatically configure with the provisioning server 120, and cause an invitation to be sent to the host device with configuration information via an email or other means.

In another embodiment, no configuration information is exchanged between the client device and host device. Instead the user executes a configuration wizard contained in the installation package on the host devices 108 and the client devices 110, causing the provisioning server 120 to initiate a pairing process, such that a unique identifier is displayed on the first device, and entered by the user on the second device. In principal, this is similar to the binding process that is standard for pairing Bluetooth Devices, with the exception that the provisioning server 120 is the enabling intermediary. Upon identification of the paired devices to be bound, the provisioning server 120 allows configuration information to be retrieved by the client applications to complete the binding process.

In another embodiment of the invention, the host application 112 may maintain a communication connection with the connection manager 118 and allow any identified client device (such as a cell-phone based mobile media presentation device which is identified by a unique identifier, such as a phone number) to connect to the host application (whether the client device is associated with the user to which the host device 108 belongs, or another user), via the connection manager. Multiple connection managers 118 may be clustered together and cooperate such that an authorized client device 110 connected to the first connection manager will be able to communicate with its paired host device 108 connected to the second connection manager. Furthermore, media and other information, such as playlists (and other indexes) of the media, may be transmitted (preferably in streaming fashion) to one or more authorized users. Additionally, purchased media offered to users from one or more server-based services 406 (see FIG. 4 and discussion below) may be received and stored in a user's collection.

In yet another embodiment, playlists or other indexes to media content on the host device 108 may be synchronized to a client application, and the host application may respond to other actions requested by the client application such as, for example, to retrieve a specific media file to be downloaded to the client device 110 and placed in storage memory on the client device by the client application. This content may be further transformed by the host application prior to downloading to the client device 110, such that it is in a format more suitable for transmission or for storage on a memory constrained client device. Such downloaded content may be played or viewed on the client device 110 as the content is being retrieved, or stored for playback or viewing at a later date, perhaps when a network connection with the host application might not be possible. Additionally, the client application may submit information to the host application, such as to change information associated with preexisting content on the host device 108, to upload new content to the host content, to invoke a plugin on the host device to perform an action, such as to purchase music to be retrieved back to the client device 110. Furthermore, a user may invite other authorized users to access the user's media by using the host application 112, and the user may configure other media preferences to be accessed on the user's client device. Examples of such media preferences may be media obtained from server-based services 406 (see FIG. 4 and discussion below) such as news, sports, financial information and the like as is well understood in the art.

Additionally, other application media player plug-ins may reside on the host device 108 associated with one or more pre-installed media players or other applications to permit access to the user's playlists, slideshows, etc., and to invoke play/stop or other actions such as to purchase new content, etc. Without limiting this disclosure, it is understood that plug-ins add functionality to an application (program) as is well known in the art. Adobe® Photoshop® supplied by Adobe Systems, Inc., USA is an example of such plug-in technology. Synchronization software such as Palm Desktop™ supplied by Palm, Inc., USA or Window's ActiveSync® supplied by Microsoft corp., USA may be configured with plug-ins to add support for a variety of different third-party applications (programs).

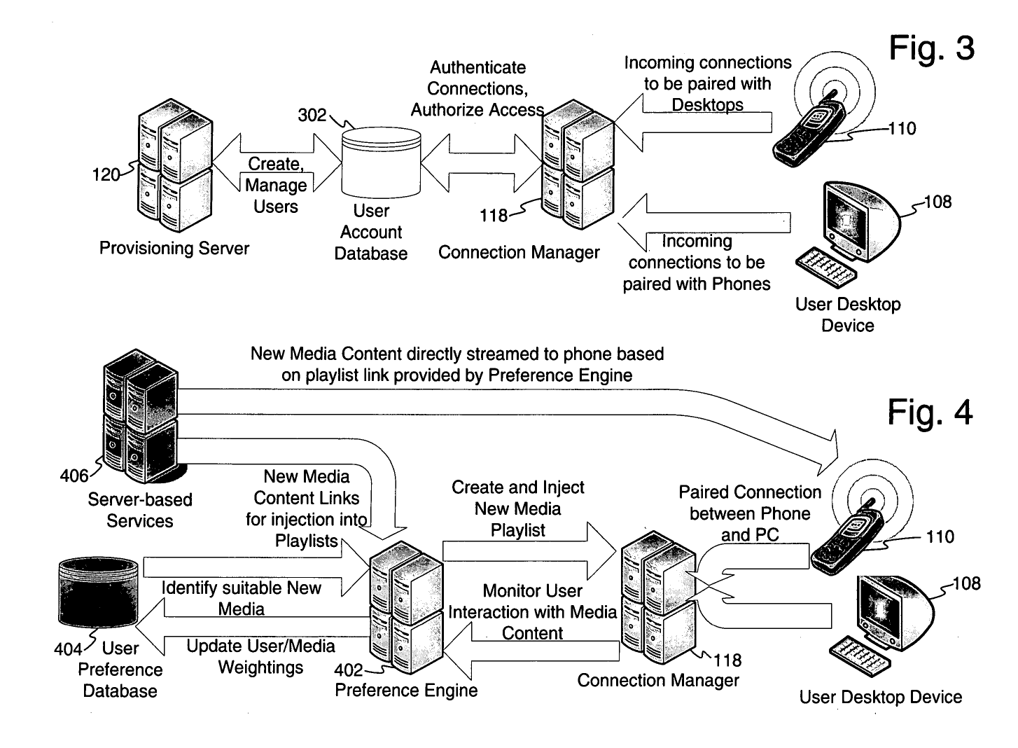

A host device configuration wizard (program or sub-program) may set up and provision the host application 112 and a user account on one or more provisioning servers 120. The provisioning server 120 may communicate with a user account database 302 to store and maintain data such as user accounts and user credentials and device pairing information. The connection manager 118 utilizes such data stored on the user account database 203 to perform authentication and connection authorization tasks (see FIG. 3 and further description below). Additionally, one or more servers may house installation applications for one or more host devices 108 and a variety of client devices 110. Of course, the provisioning server 120, connection manager 118 and/or other servers disclosed herein may be configured in one or more server systems. In one embodiment, various commercial software applications may utilize a configuration wizard to communicate to a web server in order to create and provision a user account. Of course, without limiting the scope of this disclosure this and any other mechanism well-known in the art may be used to register loaded software upon completing an installation.

Turning now to further aspects of the invention as illustrated in FIGS. 1 and 2, in one embodiment of a connection system 100, one or more connection managers 118 (only one illustrated in FIG. 1) may be intermediates between one or more installed host applications 112 and one or more client devices 110 to monitor and secure access of media on both host devices 108 and client devices 110. As discussed earlier and known in the art, in a number of commercial and open-source offerings, users may be allowed to access files on their host device from outside a firewall 116 with products such as GotoMyPC®, OpenSSH (an open-source free software project available from www.openssh.org), and Kaboodle® (available from Kaboodle Inc., USA). Without limiting the scope of the disclosure, some peer-to-peer technologies may provide file-sharing capabilities despite the presence of a firewall 116, as discussed earlier.

In one embodiment one or more connection managers 118 may comprise one or more servers on the Internet configured to permit HTTP/HTTPS or other connections such as SSH from host devices 108 and client devices 110. In one embodiment, each host device 108 may be configured to be addressable by a media player accessing a server and may be configured with a unique token created during a provisioning sequence. Furthermore, host devices 108 may be configured to be accessible behind one or more firewalls 116 (also known as firewall tunneling).

A connection manager 118 may perform authentication of a client device 110 and limit access to host devices 108 to prevent unauthorized connection to the connection system 100. In one embodiment, authentication may be performed utilizing credentials stored on a provisioning server database such as user account database 302 (see FIG. 3). In one contemplated embodiment, digest authentication comprising username, password, and/or unique identifiers for the connecting device may be used. In an alternative embodiment, public/private key authentication may be utilized. Furthermore, a connection manager 118 may perform authorization checks on host/client device pairings, such that only authorized connection pairings are able to establish communication and transfer media content and other data between the paired client and host devices.

In yet another embodiment, connection managers 118 may allow media from a host device 108 to be transmitted (such as in streaming fashion) to a client device 110 and also authorize requests from a client device to be sent to the host device. Such transmission may be streamed (or chunked) in a manner such that disconnections or interruptions in the transmission do not require the re-transmission of the content from the start, but allow transmission to continue from or near where the previous transmission ended. Alternately, a simpler FTP (File Transfer Protocol) or HTTP style download may be used such that failure requires the entire transmission to be re-attempted. Furthermore, a connection manager 118 may allow one or more preference (or personalization) engines 402 (see FIG. 4 and discussion below) to access one or more connected host or other devices to monitor content flow. In one embodiment connection managers 118 may be configured to allow server-based services 406 to advertise playlists and media and offer these for purchase in a client application on either host devices 108 or client devices 110. A user's host device(s) 108 may also be configured to receive purchased media delivered by one or more server-based services 406 (see FIG. 4 and description below).

In operation, after a connection installation package is installed as a host installer 104 from a product website 102 (see FIG. 1), a configuration wizard may create or request input for data such as a user identification (UserID), a password, an e-mail address, a phone number (or other client device identifier/access code) on a provisioning server 120 to facilitate authorized connection to a connection manager 118. A unique host token may also be generated by the provisioning server 120 and stored, along with the user account information, on the user account database 302, to provide the necessary authorization and device pairing information needed by the connection manager 118. Additionally, the provisioning server 120 or a host device 108 may generate and share public/private keys to further secure the connection process. Similarly the client device 110 would perform similar actions, such as causing a unique identifier to be generated at the provisioning server 120, causing the public/private key to be generated and shared, and creating a paring with a host device, which is stored by the provisioning server on the user account database 302. Host services may be registered to permit access to one or more external host applications such as iTunes®, Remote Desktop, a personal web service and the like. A user may now initiate one or more host applications from the host application 112 and connect to a connection manager 118 to permit external access by a client device 110 outside of the firewall 116. The client device 110 may be configured by the client installer 106 with a client installed package 114 (see description above). As illustrated in FIG. 1, the host application 112 initiates an outbound HTTP or HTTPS or other connection to the connection manager 118. Such a connection may use a —R SSH connection, a SOCKS proxy or the like as is well understood in the art. Each host application may also launch any registered application if the registered application is not currently running on the user's host device 108.

One or more servers configured as a Carrier Messaging Gateway 124 (see FIG. 1) may send invitation messages to one or more client devices 110 for configuration/installation of a registered client application originating from any host application (see above) and to pair the client device to the host device 108 or any other shared music location (or other media). Without limiting the scope of the disclosure, this may be accomplished by one or more known methods for deploying applications on any phone from a standard library in the J2ME MIDP 2 (see Glossary above) specification. In these methods an application can be retrieved and installed, triggered by a message being sent via SMS or a specific Teleservice ID (see Glossary above). It is understood that the Brew® OS (see Glossary above) may operate similarly. As illustrated in FIG. 1, the SMS or Teleservice ID message may be linked to the client device 110 with a combination of an installer link and the generated host token (see above).

In another embodiment of configuring a connection system 100, referring to FIG. 2, a client device 110 may drive a remotely initiated installation of the connection installation package (briefly described above). The remotely initiated installation may provision a user account with a username (UserID), a password, a phone number, and email address on a provisioning server 120 as described earlier for a host device initiated installation (see FIG. 1 and the description above). Furthermore, the provisioning server 120 may be linked by the installation to an e-mail server 202 to send invitation messages to a user for configuration/installation of a user hot device package. Without limiting the scope of the disclosure, emails with HTML links may be used to facilitate download and installation of an application as is well understood in the art. After installation of a host application 112 on a user host device 108, a unique host token may be generated and stored on the provisioning server 120 as described earlier for a host device initiated installation (see FIG. 1 and the description above). Of course, the installed application package 112 may be configured on the user's host device 108 and configured to communicate with pre-existing applications 122 and a connection manager 118 in the same fashion as described earlier (see FIG. 1 and description above).

Referring now to FIG. 3, one or more provisioning servers 120 (one provisioning server shown in FIG. 3) may comprise one or more servers or other computing devices which are responsive to client requests from client devices 110 to provision user accounts, manage user accounts and user credentials, unique device identifiers and keys and to store relevant data on a database. Furthermore, the provisioning servers 120 may perform record tracking (for billing purposes) of newly played media and may link with online media stores (or sites) for the purchase of new media. In a preferred embodiment, music purchased by one or more users may be added automatically to one or more users' host device media collections. Moreover, the provisioning servers 120 may provide a website for users to log on and manage their user accounts, provide administrative functionality for managing accounts, billing and promotions. Additionally, users may log on to one or more websites on the provisioning servers 120 and manage their personal profile (personal information including but not limited to personal preferences), add or remove other profiles, news, syndicated programming, and the like. Users may also upload pre-existing playlists from their own host device 108 to be incorporated into their profile.

User information (or data) may be stored on one or more provisioning servers 120 or any other servers communicating with the provisioning servers 120 in one or more user account databases 302 (only one shown in FIG. 3). In one embodiment, such user information (or data) may include user ID's, passwords, host (or desktop PC identity) tokens, phone numbers, email addresses, account information, and billing information. The user account databases 302 may be further accessed by one or more connection managers 118 (only one shown in FIG. 3) to authenticate connections and authorize access between paired client devices 110 and host devices 108 as illustrated in FIG. 3 and also described above.

Referring to FIG. 4, in an exemplary embodiment of the invention, a preference (or personalization) engine 402 (configured as one or more servers) may track user preferences and mix in new media to a user's listening/viewing choices with a high probability that the user will enjoy and subsequently purchase such media.

The preference engine 402 may identify media located on one or more host devices 108, which devices may be connected either actively (connected directly) or passively (identify media as it is retrieved by a client application). Furthermore, based on monitoring playlists and user interaction on the client application such as, for example, media which is selected, skipped and/or repeated, specifically retrieved from the host device 108 as opposed to automatically retrieved by the client application, user favorite media and disliked media may also be determined. Personalized playlists may be created and new media that the user does not have but would likely suit the user's preferences may be incorporated based on user preferences. These playlists can also be based on themes such as Dance, 80's, Spotlight Artist, and so on.

In this embodiment of using a preference engine 402, it is contemplated that all host media accessible by a user may be tracked and a weighting applied to each item of media based on how often it is accessed, how a user reacts to its presentation (e.g., skip, repeat), and so on. Media not owned by the user but which received high weights from other users who share high weightings in a wide cross-section of common media in the same genre, tempo, or other criteria, may be considered as new media candidates to be offered to the user. Of course, other weighting methodologies may be utilized. This may be offered as a small list of “related” content for the currently playing media (e.g. songs by same artist, in the same film, same genre) or as a playlist of new media content, intermixed with user owned media and also based on genre, film, artist, etc. As a consequence, the user of the client device 110 would be able to have an ongoing personalized selection of owned media synchronized to the user's device, along with recommendations of new media that may be elected for purchase. Subscription or other service allowed download of new content without outright purchase, new content could be synchronized automatically as well based on the preference engine's generated playlists.

In various other aspects of the preference engine 402, it is contemplated that personalized media may be selected based on a database of user favorites and dislikes. Favorites from other users who also like another user's favorite tracks may also be associated with the user. Based on what the user is currently playing, the preference engine 402 may provide a “6 degrees of association” list that has related media to the current content. The list may subsequently be queued up for playback if desired.

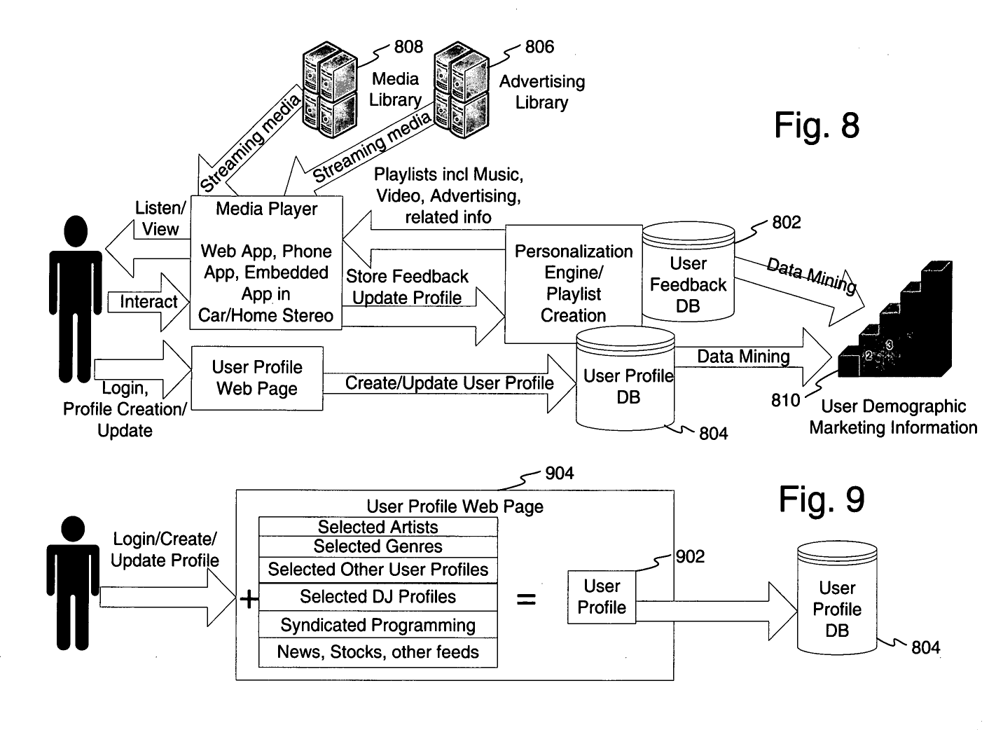

In another aspect of the invention, and referring now to FIG. 8, the preference engine 402 may enable that such playlists be accessible on either the client device 110 or the host device 108, and may transmit such media from a media library 808 (one or more server-based locations). Furthermore, additional global media playlists may be created and such media may be streamed to any user who chooses to play such lists (sports categories, news, finance are examples of such lists). Such global content may have such preferences associated with it as traffic news at the top of every hour, local news at 6 pm, etc., which could be streamed in real-time if a connection from the client device 110 was available, or synchronized later when such connection is available. Optionally, (as shown in FIG. 8) the preference engine 402 may provide notifications of upcoming concerts based on a user's favorite media preferences and incorporate advertising content from an advertising library 806 (one or more servers), whether it is formatted as audio, visual, or hyperlinks (based on user preferences) and the preference engine may be updated by user feedback to this advertising content.

Of course, the preference engine 402 may be a component of one or more server applications or be separate servers entirely. Furthermore, the preference engine 402 may operate in conjunction with a connection manager 118 and connected hosts, or solely utilize one or more server content libraries.

The preference (or personalization) engine 402 may incorporate user feedback (see FIG. 8 and description below) to alter future content to be transmitted to a client device. In conjunction with the personalization engine 402, a client application may be a Web Application (see FIG. 11 and description below) accessed via an Internet browser, a phone application, a purpose-built wireless media player, an embedded application in a car or home stereo, or other such device or any combination of devices (cable box and television) configured to play media and advertising content.

Referring again to FIG. 4, the preference (or personalization) engine 402 may be connected to the connection manager 118. The preference engine 402 may index and perform manipulations regarding the contents of the media on any host devices 108 connected to the connection manager 118. Furthermore, as described earlier, one or more client devices 110 may be paired to one or more host devices 108. In one embodiment it is contemplated that the preference engine 402 would track user selections and interactions (or preferences data) with the client device, store these preferences data in one or more user preference databases 404 (only one user preference database depicted in FIG. 4) and utilize this data to affect the content of future playlists, and the like presented to a user on the user's host device 110. In one embodiment the user preference database 404 may store media records cross-referenced with user preference weightings, so that the preference engine 402 may identify content not currently in the user's content library but which the user will have a high probability of enjoying and possibly purchasing.

Furthermore, still referring to FIG. 4, the connection manager 118 or the preference engine 402 may be connected to one or more server-based services 406. In one embodiment it is contemplated that the server-based services 406 may provide access to new media, including but not limited to photo sites, peer-to-peer music sites such as Grokster, existing and future online music stores such as those from Apple Computer, Walmart, BitTorrent and the like.

In one exemplary embodiment of the invention, it is contemplated that these services may provide a new source of media for a device designated herein as a personalized music radio (see FIG. 6 and description below). In one aspect the personalized music radio may comprise any client or host device (as described above) which may receive any type of distributed media such as syndicated programming, news feeds, advertising content, other groups or cluster of media and the like. In one embodiment the distributed media cluster may be multi-path streamed to any client devices. Furthermore, a media catalog database (possibly incorporated with the user preference database 404) and user profile data may provide content and location information through one or more servers such as the preference engine 402, and various other servers such as content mixer/filter and branded portals. This contemplated personalized music radio may provide for user interaction with any or all of the servers discussed above to facilitate the users' media experiences.

FIG. 5 illustrates a schematic flow diagram of how content from a host device 108 may remotely control presentation of media. Initially, a client application 502 configured to display media (such as a list of files), playlists and/or receive user inputs, may reside on a client device 110 and may connect to a connection manager 118. The connection manager 118 may be connected to at least one of a plurality of host devices 108 to access the media therein, preferably in a streamed format. When configured in one embodiment as a remote control, the client device 110 may interact with a plurality of source players at one or more host devices, instructing a player/application such as iTunes® (and/or other plug-in applications) to play content as if each user was at the host device, as well as enforcing rules to prevent other users without ownership rights from having control of the media. Referring to FIG. 5, a user may retrieve and select media to be played by displaying the media on a client device display. In one embodiment it is contemplated that a selected action such as play, stop, pause and the like commands may then be relayed back to a selected host device, such as a home stereo 504 (depicted in FIG. 5) where a plug-in may ultimately invoke a resident media player to respond to the selected action. The plug-in may utilize a resident media player's exposed programming interface in order to control the player. Furthermore, a connection proxy may provide a content index, playlists wirelessly accessible by the client application 502 and one or more user instructions requiring an action or response from the user.

FIG. 6 illustrates a schematic flow diagram of how content from a host device 108 may be synchronized to one or more client devices 110, with items 604 illustrating the equipment to which the client device could be connected to or embedded within. For instance, a car or home stereo may function as a client device 110, containing a client application, or may simply be connected to a client device such as a phone, via wired or wireless means. A host or other pc may also be the client device 110, connected via a client application through the connection manager 118 to another authorized host device 108. As described above with reference to FIG. 6, a client application 602 (shown in FIG. 6 as being associated with a cell phone 110, but without limiting the scope of the disclosure may be associated with any suitably configured device) may be connected to one or more user host devices 604 via a connection proxy that may circumvent restrictive firewalls 116. In a preferred embodiment, the playback devices 604 are client devices 110, but may comprise a variety of devices capable of presenting media, including devices with limited functionality.

Alternately, in another embodiment, the playback device 604 may comprise a purpose-built media player that is not a phone, but which has communication capabilities, be it wireless or wired. In one embodiment when the playback device 604 is configured as a wireless MP3 player, the MP3 player may retrieve its media streamed from a plurality of host devices 108 instead of being cradled and synchronized onto a hard-drive or being memory resident on the playback device. According to the MP3 player embodiment, when using this player, there is not simply access to server-based streamed radio. Instead, difficult-to-access private content may be streamed to the device 604 via wired or wireless means. It is contemplated that this embodiment of a device 604 may be implemented with a combination of a media player application on the client device 110 connected via a connection proxy based VPN (utilizing a connection manager 118 and outbound (HTTP, HTTPS, SSH or other host connections) to access media and playlists on the connected host device 108 via media player plug-ins. One or more plug-ins may extract content information and playlists to be fed back to a client application 602 for content navigation purposes and to stream content when requested by the client device 110 (such as the MP3 player), either automatically by the client application based on user preferences and other criteria, or explicitly selected for retrieval/playback by the user.

Advantageously, a user may hardly notice any difference between this client device 110 (configured as playback device 604), and another conventional device that has onboard memory playing media that has been physically synchronized. Playback device 604 would have content that has been synchronized via a communication network to onboard memory, as opposed to being physically connected to the host device 108. Additionally, the above-described media player may improve the performance of the content playback while playing content as it is being streamed by reading ahead and caching content such that when the connection is lost, playback is not abruptly halted. It is contemplated that read-ahead content may allow playback to continue when the connection is momentarily lost. The client may be subsequently switched to cached favorites, allowing music to continue to be played through long periods of connectivity loss. It is further contemplated that the host application 112 may also down-sample media if made necessary by a slow network or if desired by the user or a service vendor to, for example, reduce image size to a format more appropriate for a client device or reduce music sampling rates for quicker transmission.

With further reference to both FIGS. 5 and 6, in one embodiment, a client device 110 may be configured as a phone-based device or may be specially configured with a suitable amount of memory for media or other data storage. The client device 110 may include various features such as a headphone jack for playback, and may implement various communication protocols, such as a 3G (or any future high bandwidth network system) networking for streaming of wireless media. Additionally, the client device 110 may have SMS messaging capability for receipt of configuration messages, a joystick or other input device, and use J2ME or Brew® or other OS (see Glossary above) for any client application. Preferably, the client device 110 may have a display for playback of video media (although an audio-only device could work with a simple black and white screen). It is contemplated that the client device 110 configured as a player could be simply a low-budget MP3 player-like device with associated wireless capability (3G and/or WiFi, etc.) or be a purpose-built streaming video player with or without built-in phone functionality.

Referring back to the description above of the features of the system illustrated in FIGS. 1 to 6, a contemplated client application may perform various media player functions such as play, stop, pause, forward, backward, etc. Additionally, a client application may retrieve and invoke playlists of media stored on a host device 108 and/or create additional playlists of its own, possibly to be synchronized back. Furthermore, a client application may cache favorite songs and pre-fetch songs in the active playlist into a media player's memory, such that music can continue to be played regardless of network coverage. Pre-fetched songs may be played first followed by cached favorites until coverage returns thereby avoiding connection loss.

In other embodiments, one or more client applications may fetch global and user-specific playlists generated by one or more server components, and retrieve media as specified by such playlists, either from the host device(s) 108 or any server-based services. Client applications may receive notifications from host devices 108 and other sources allowing access. For instance, a first user may enter a phone number or other client device identifier for a client device 110 to be invited to access the first user's media collection located on the first user's host device 108. The other user's client device 110 may receive such notifications and add the source as another option and present the playlists and content of this new source as new options. Alternately a Bluetooth style pairing wizard could be utilized, with the new host application displaying a unique id on the host device 108 that could then be entered on the client application, with the bind procedure being choreographed by the provisioning server 120. A Wide Area Network (WAN) connection to a provisioning server 120 is preferred in comparison to a Bluetooth headset connection to a phone because of the current limited range of Bluetooth. It is contemplated that should Bluetooth be improved, this form of wireless communication may also be suitable. Without limiting the scope of the disclosure, it is contemplated that any suitable wireless connection may be used.

Additional features of a client application may be to inform a preference (personalization) engine 120 about favorites and new media that may be liked or disliked by one or more users. Digital rights management and license acquisition may also be incorporated. Furthermore as explained above, client applications may provide for purchase of media received from a server-based service 406 (see FIG. 4) either directly or by instructing a host application on a host device 108 to perform the purchase, and optionally function as a remote control of a media player situated on a host device, such as to transmit music to a stereo or other connected player (see FIGS. 5 and 6 and description above). Optionally client applications may provide other functionality such as create ring-tones, wallpaper, screen savers and the like from a streamed media.

Further contemplated features of client applications may include: allowing a user to view upcoming concert notifications received from a server application, purchase of tickets and play personalized radio content streaming from server content libraries, as determined by a personalization engine 406 streamed from server content libraries (refer to FIGS. 8 and 9 and description below). As also illustrated in FIGS. 5 and 6, client applications may be built into a wireless device, a car or home stereo, a web client, or a PC application.

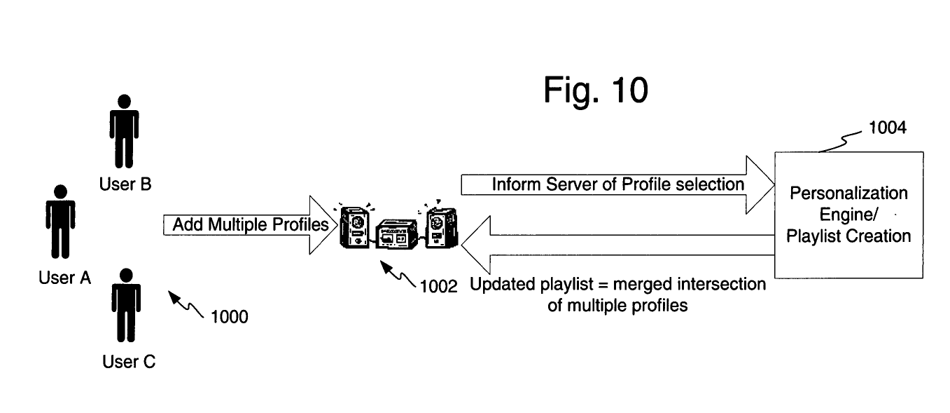

Furthermore, client applications may be shared by multiple users individually at different times, or simultaneously by streaming media matching the intersection of the combined profiles of the multiple users who may log into their personal profiles (see FIG. 10 and description below).

When client applications are configured in a mobile player (client device 110) to purchase media, the content may be automatically delivered to a purchaser's host device 108, after which that content is further delivered to the client application. In one embodiment, when a user elects to purchase media with a client application, the application may send instructions to a host application associated with the user's host device 108, and the user's host application may initialize the purchase request to an online music store, downloading and storing the media content upon successful conclusion of the purchase transaction. It is contemplated that purchase information could be either stored on a user account database 302 (see FIG. 3 and description above) or locally on the user's host device 108.

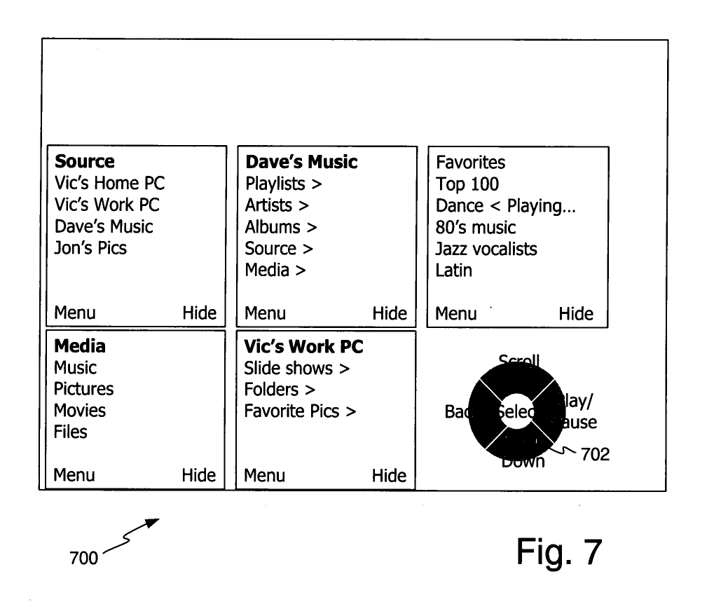

FIG. 7 illustrates various embodiments of information which may be presented or displayed by a client device 110, such as by a video display thereof. Of course, this information may be individually or simultaneously visible to one or more users. In one embodiment, the information comprises various displays or graphical user interfaces. When configured as a media player user interface, the displays may be configured in a similar fashion to many MP3 players currently available in the market and include additional options to select source PC (or host device 108) and-content types. A 5-way button currently found on most cell phones (depicted in FIG. 7 as button 702 with various options such as scrollup, scrolldown, back, play/pause and select) may serve as a primary control for the client device 110. However, without limiting the scope of the disclosure, as is well known in the art, number keys (not shown) may be utilized in a similar fashion, with the number 5 key forming a center (select) button.

Referring now to FIG. 8, the preference (personalization) engine 402 may incorporate user feedback on media and other information. Such user feedback may be stored as one or more user feedback databases 802 (only one shown in FIG. 8) resulting from user interaction and delivered media. The type of user feedback, media affected by the feedback, and the time of the user interaction may also be stored in user feedback database 802. Additionally, one or more user profiles 902 (see FIG. 9) may be stored on one or more user preference databases 804 (only one shown in FIG. 8). User preference databases 804 may comprise user account information, other profiles the user has selected to adopt (see FIG. 9 and description below), news/talk shows/other programs the user has added, user interaction to content that has been streamed to the user, and the like. Preferably, in one embodiment this user profile 902 may facilitate selection of content (media, advertising, hyperlinks, etc.) to be streamed to a client application by the preference engine 402 and may be dynamic in nature, constantly being updated as a user interacts with a client application and a provisioning server 120 configured with a website.

FIG. 9 shows how a new user may create a new user profile 902 on a user profile web page 904. Additionally, FIG. 9 illustrates how an existing user may modify a current user profile 902 by logging onto a website ( such as the user profile web page 904) to select an artist, genre, song, talk show, syndicated program, another user profile, a DJ/Club/Broadcaster profile (which may include live programming intermixed with static content) and the like. Furthermore, the existing user may add this profile information to the existing user's profile 902. Consequently, the user's personal profile 902 may comprise a combination of multiple songs, artists, other user profiles, and the like. Subsequently, a user may also remove any information items from the user's profile 902 or elect to increase and/or decrease preferences for these items while still keeping them in the user's profile 902. All these changes may be stored thereafter in one or more user profile databases 804 (see FIG. 8 and description above) and utilized to determine future content streamed to the user.

Additionally, in a further embodiment it is contemplated that a user could create a category of music based on an activity, such as dinner, selecting a specific genre, tempo, group of artists, and the like to be played. The user could select which category may be played at any time. For example, when configured in a preference engine 402, the preference engine could determine that a category (such as a WorkOut category) be played regularly during weekdays at 9AM and provide that playlist for the client application to automatically start retrieving and caching content for this category when certain pre-defined conditions are met.

Referring now to FIG. 10, in a contemplated embodiment multiple users 1000 may utilize a single client application to create a composite profile comprised of common preferences of all users. For instance, three people at a dinner party could login to their profile utilizing an embedded client application in, for example, a home stereo 1002 and hence inform one or more personalization engines 1004 that this player (the home stereo 1002) is to receive a playlist that is an intersection of the three people's profiles. The client application embedded within the home stereo would subsequently retrieve and play content identified in the playlist. Of course, less or more than three people may participate.

In an exemplary embodiment user could hear a song on a radio and utilize the client application to record a song “snippet” may be sent over a data connection to a server-based service 406 to aid in identifying the song. Subsequently the song may be identified, retrieved and queued for playback (if permissible) and permit the user to ultimately purchase the song.

FIG. 11 illustrates an exemplary sample display 1100 of a web-based media player configured as a portion of a client application. As configured in this specific example, the Web-based media player denoted myRadio.com may be accessed via an Internet Browser. Of course, as described earlier other web-based media players may be available.

3. Exemplary Implementation of the System

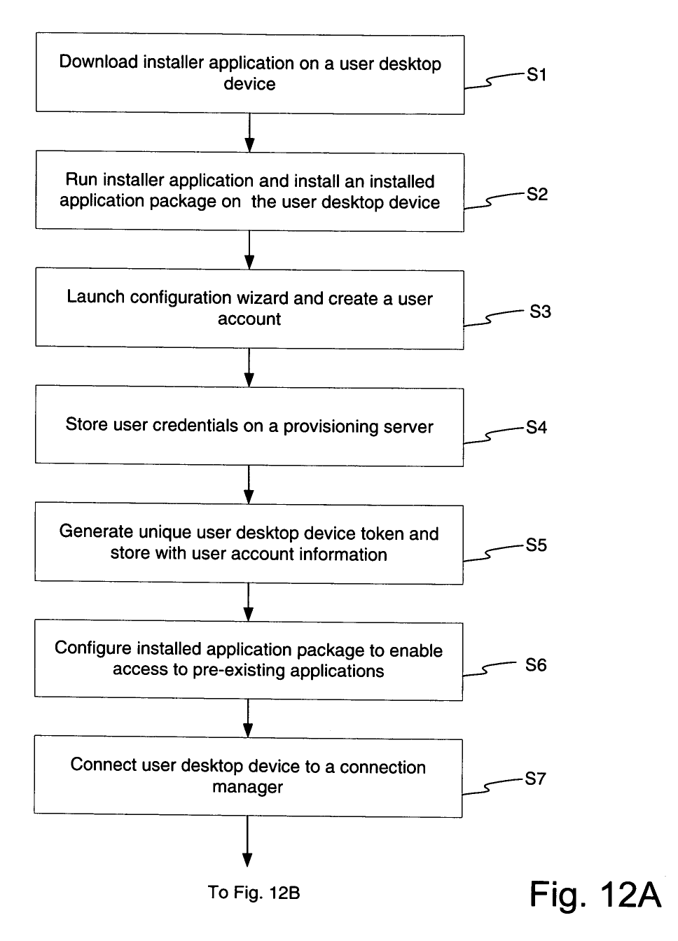

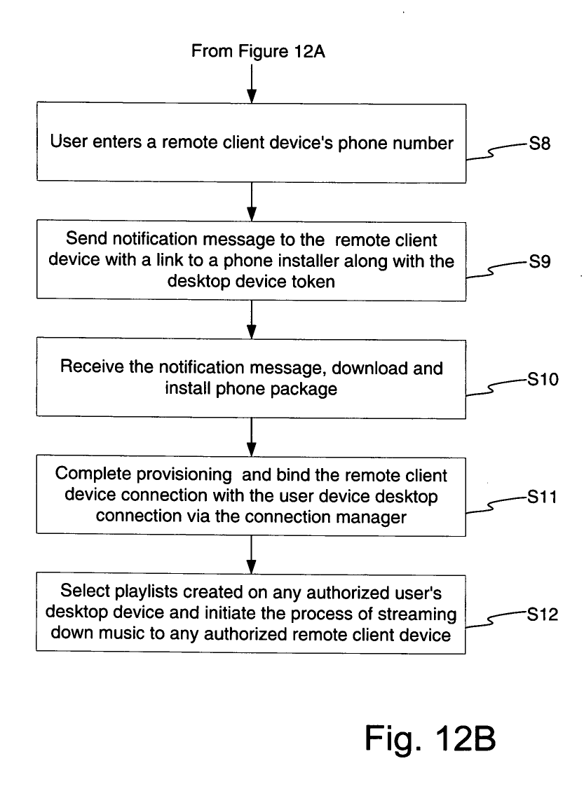

An exemplary method of installing and implementing the connection system is now described with reference to features shown in FIGS. 1 to FIGS. 11 and more particularly with reference to steps of the flow diagram shown in FIG. 12A and FIG. 12B.

In a first exemplary embodiment (see also FIG. 1), in step S1, a user may download an installer application 104 from a product website 102 onto a host device 108 and in step S2, the user may run the host installer application 104 to install one or more host applications (host device installer package) 112. In step S3 a configuration wizard may be launched to create a user account comprising UserID, password, e-mail and phone number. In step S4, user credentials (user account information) may be stored on a provisioning server 120 (see FIG. 3). A unique token identifying the host device 108 may then be generated and stored with the user account in step S5. In step S6, one or more pre-installed pre-existing applications 122 comprising one or more plug-ins for media players/organizers, such as iTunes®, iPhoto® or Windows Media Player, may be configured with the installed application package (host applications) 112 to enable access by to a user's media collection and playlists, slideshows, and the like.

When these installation steps are complete, in step S7, the installed application package 112 (desktop or host application) may connect to and maintain an open connection to a connection manager 118 (server component) in order to make the host device contents accessible from a client device 110. This outbound connection from the host device 108 enables access to the host device from a network or via other communication links, such as the Internet, regardless of any firewalls 116 that may be in place.

In step S8, a user may enter the phone number or other client device identifier into a host application to permit access to the user's media on the host device 108. This phone number or other identifier may correspond to a client device 110 belonging to the user or another party. Of course, more than client device 110 may be permitted to have access to the user's media.

In step S9 the host application may then instruct the provisioning server 120 to send an SMS, Teleservice or other form of notification message to the client device 110 identified by the specific phone number with a link to an installation package (client installer) 106 for the client device 110 stored on the product website 102 along with the unique host token (see above).

In step S10, the client device 110 may receive the notification message and either an automatic installation tool may download the installation package (client device installer) 106 and install it, or the user may manually activate the link in the notification message to initiate downloading and installation of a client installed package 114.

Upon completing the installation of the client installed package 114, in step S11, the client device 110 may complete provisioning with a configuration wizard, utilizing the host token to bind the client device's communication connection with the host device's communication connection via the connection manager 118.

The connection manager 118 authenticates connections from client devices (or client applications) and from host devices/applications, ensuring that only devices from registered users can connect and pair with each other according to any granted permissions. For instance, a client device 110 may only connect via the connection manager 118 to host devices 108 with which it has been successfully paired, such pairing information having been stored in the user account database 302 accessible by the connection manager. Conversely, host devices 108 may only transmit or provide data to client devices 110 to which they have been successfully paired. Connection managers enforce authorization rules. Additionally, host applications can further enforce authorization rules.

Once the system has been configured, in Step S12, a user is able to select playlists (referencing media) that have been stored on the user's host device 108 and also playlists on any other authorized user host devices and initiate the process of downloading music to any authorized client device. Authorized users may select individual songs, entire albums or works by a particular artist for playback. Similarly, users may initiate media such as a slideshow or to watch music videos, if the client device 110 is configured to be capable of receiving such media. Additionally, the client application may be configured to automatically download content based on preference settings on the client device 110, such as time, frequency, percentage of storage memory to refresh, song ranking, as well as other criteria such as network availability and usage costs.

As described above in an alternate embodiment of a method for installing a connection system as illustrated in FIG. 2, a user may initiate the installation/provisioning process on the client device 110 by going to a WAP-based (wired or wireless) product website 102 and by downloading and running the client installer 106. In this case, a client device wizard may provision the user account on the provisioning server 120, after which a client application may connect to a connection manager 118. A host device's email or networking address may then be requested and the provisioning server 120 may send an email or other message, with a link to the host device installation package (host application) 112 and the phone number or other client device identifier for the client device 110. Upon returning to the user's host device 108, the user may retrieve the email, click on the link and complete the provisioning process. The provisioning server 120 would store the pairing of the client device 110 and the host device 108 in the user account database 302. A host application 112 would then connect to a connection manager 118. The connection manager 118 may subsequently bind the client device connection to the host device connection, upon verifying the pairing information exists in the user account database 302.

In alternative embodiments of the method illustrated in FIG. 2, installation of the client installed packages 114 on the client device 110 may also be initiated by a promotional email SMS message from a carrier or other vendor containing the link to the client installer 106, or a carrier or phone manufacturer could burn an image on a ROM of the client device 110 to preload the client installer 106.

Additional embodiments of the method illustrated in FIG. 2 would is recognize that the host and client applications are installed and configured and a pairing process would be initiated whereby a unique identifier provided by the provisioning server 120 is displayed on one device and that same identifier is then read and entered by the user and a second individual into the second device within a short time span. That identifier may be entered in the second device and submitted to the provisioning server 112, which then binds the two devices participating in this process. In a preferred embodiment a time span binding identifier is valid for a predefined value, outside of which it would no longer be valid and the process would have to be restarted, with a new unique identifier being generated for the pairing process. A time span associated with the time span binding identifier is configured at the provisioning server and may be a period as small as 30 seconds and as large as 24-48 hrs.

4. Further Implications and Advantages of the System

As eluded to earlier, preferences for a client application may include many different features. In one embodiment, a percentage of memory may be set to define the size of media caching, enabling a mobile media application to intelligently cache favorite songs and images and perform read-ahead buffering of content to be played/displayed. Media caching may enable a media player to continue to function even when a wireless connection is lost, as the media player is able to play from a read-ahead buffer during intermittent brown-outs and revert to cached music during a long connection outage. These preferences also enable the client application to perform automated synchronization of host content at predetermined intervals, refreshing the client cache with new content.

Alternatively, a media player could connect to strictly server based content, without requiring a connection manager 118 or being connected to a host device 108. In such a system, a preference engine 402 may track user profiles and deliver media, via a playlist based on users' preferences. As a user interacts with delivered media, by skipping, repeating, voting, and the like, the preference engine 402 may update the user's profile, using this to modulate what is delivered to the user in the future.

Alternately, a media player could connect directly to a host device 108 when it is in a network where that is possible (i.e. within range of the host device's wireless network and/or behind the firewall 116). Subsequently, a connection manager to facilitate a connection would be optional. In its simplest form, the host application would enforce binding and no server components would be necessary. Automated synchronization, remote control functionality or user initiated download/playback would continue to function.

As configured in FIG. 1, the user interacts with media received by a client device, such as media player, by listening and/or viewing with no action, skipping the content, repeating, voting (love, like, dislike, hate, numeric value or any other suitable indicia), clicking on a hyperlink, and so on. Such user interaction, media playing at a time of interaction, and a time of user interaction may all be uploaded to the personalization engine 402 and stored in a user feedback database 802 as information. This information can be processed in real-time or at some delayed period, such that the user profile database 804 is updated to reflect user preferences. Data-mining (see FIG. 8) of the user feedback database 802 and the user profile database 804 may be utilized to create Marketing Demographic information 810 (as illustrated in FIG. 8) to drive advertising and marketing studies. Such demographic information 810 may allow advertising to be more directly targeted to users with preferences for such advertisements (i.e., when users responded with “like, repeat, hyperlink” and the like on similar advertisements) and not to users with dislike for such advertisements (i.e., when users responded negatively to certain types of advertisements). Advertising may also be targeted based on time of day, political leanings and so on (i.e., when users listen to certain bands, talk shows, etc. from which political or lifestyle preferences can be determined). Hence, an updated user profile 902 (as illustrated in FIG. 9 resulting from User Profile Web Page 904) may result in future media and advertising content being delivered to the user, determined based on user preferences/dislikes.

In addition to media and advertising content, playlists sent to a media player may contain web hyperlinks and other textual and/or image data to be displayed on the media player. This playlists information may be related to the media currently playing (i.e., advertising, related music, concert information, etc.). While viewing and/or listening to the audio/visual content a user may see this as sideband information and elect to click on it to see more information, purchase or save this information. A user's interactions may also be tracked by the personalization engine 402.

A playlist may contain hyperlinks to actual media. The client device may utilize those hyperlinks to retrieve media for presentation. The client device may retrieve the media from multiple media source simultaneously, caching and buffering future data until such time that it can be played. This allows for playback even during short-term loss of connectivity.

Other variations of features and embodiments of the system are contemplated. It may be possible to immediately convert a playing song into one or more ring tones, turn a retrieved image into wallpaper and search for host device content (e.g., Google desktop style function). It may be further possible to send found media to fax, e.g., a Word document or to send found media to email, e.g., a spreadsheet. In another embodiment it may be possible to find and retrieve contact/appointment information.

As described earlier, a familiar MP3 interface may function as a remote control for selecting music that iTunes®/Windows Media Player/MusicMatch may send to a home stereo. Playlists and media accessible when the user selects a remote control mode may be limited to those of the user's personal machines. The user may be presented with a choice of “owned” host devices to control.

When a client device is bound to a host device 108, the owner of the host device may indicate that the client device would have either owner or friend (authorized other user) access. The host device may store client device identification/access information and/or access status data and may enforce this as a rule. Upon connection to the host device, the client device may be able to retrieve its status with respect to the host device, thus indicating to the client application that certain playlists were restricted, remote control mode and music purchase capability was disabled.

In yet another embodiment, a video out circuit on the client device may enable users to attach the device to a television to stream a slideshow or video for friends and family. A microphone would allow recording of song snippets to be sent to a server-based service 406 for identification. As discussed above, optionally an identified song resulting from the snippet may then be purchased and retrieved.

In yet another embodiment a personalized radio service may be configured, either integrated with host device content, or completely based on server content libraries, streaming media and advertising content to listeners on wireless, embedded (internet enabled car/home stereos, etc.), web-based and PC-based media players.

In an embodiment of a personalized music radio service, users may have access to the user's music library and it may be possible to determine what constitutes a user's favorites. Also, it may be possible to determine the favorites on another user's shares. Thus with preferences information, it may be possible to determine whether users share common favorite songs. In this manner, servers may create dynamic playlists of new music with a high probability of acceptance, which could be provided as an additional choice (or selection) on a configured client device.

Alternatively, as described earlier, radio may be connected to peer-to-peer services, such as Grokster, or subscription based music services for music access. Alternately, no host device content may be required. Server content libraries could be utilized, providing access to any and all media at any time. In this scenario, no connection manager 118 or host device 108 would be required.

In an embodiment of a personalized music radio, a user may hit a ‘back’ key to replay a past song, or a ‘forward’ key to skip a song. Furthermore, such user interactions on songs could be tracked by the personalization engine 406 to modify the selection of media streamed to the user in the future. In other embodiments, when playing a song, an “Artist Spotlight” choice may be presented to the user and this interaction may create a list of songs by the same artist. Alternatively, other songs of the genre, decade, artist, album, etc. could be presented as playlists or sideband information. In general new music not owned by a user may be presented to the user and perhaps intermixed with some music that is not owned by the user. It is contemplated that these embodiments could be based on royalty arrangements with content suppliers paid for by advertising.

As another feature of a personalized music radio, for each song that is playing an “Other Favorites” list could be presented, giving a user an opportunity to s listen to new songs that are not currently owned by the user. Songs may be categorized in any way such as same artist, from same movie, etc. to provide a “6 Degrees” choice to the user. Of course, when each new song is played, either through the use of a media player or a personalized music radio, the user may exercise a “Buy Now” option and songs purchased may be automatically added to the user's host device music collection. It is contemplated that the “Buy Now” option would be a prominent UI (User Interface) element on a phone screen (or any client device display) when new songs are played. In this scenario, content not purchased on the client device 110 would be protected by a digital rights management scheme such that the content could not be copied or even played more than a fixed number of times. It could even be immediately removed after playback. Furthermore, in one embodiment it is contemplated that purchased songs may be added to a user's playlist while non-purchased songs may not be added to the playlist. Furthermore, a list of existing playlists or a choice to create a new playlist could be presented to the user, and these playlists may be synchronized with a user's host device 108.

In an embodiment where client devices 110 are configured as wireless MPEG players, the players may stream movies, television shows, funny advertisements, music videos, sports, and the like. Such media players may provide presentation of related programming and favorites, originating from a user's favorite collection of videos, and the like located on the user's host device. Of course, news, sports, financial data streaming may also be added as further media data. In one embodiment this media data may be ticker-taped along the top or bottom edge of a phone screen (or other client device display). In yet another embodiment a song lyric may also be accessed and ticker-taped together with the song during the song's playback. Of course, when a device is configured with sufficient bandwidth, music videos and regular music have common media features. From a revenue viewpoint, music video sales may offer higher returns than audio sales.

In a similar fashion, advertisements may be presented. It is contemplated that a personalization engine 406 monitoring user response to advertising may personalize future advertising to a user.

In yet another embodiment of a method for using a client device 110, such as a media player or cell phone, an alert on a display may indicate upcoming concerts of a performer if a user had recently played a performer's song, has the performer's song listed as a favorite or if the performer's song has been played often by the user. An “Upcoming Concerts” option located on the device's display may let users view the details and elect whether to purchase concert tickets. Furthermore, each concert may be linked to a playlist of songs from the performer that may be played. The playlist may comprise songs that are currently on a user's playlist or new songs which may be added to the user's playlist.

While various embodiments of the invention have been described, it will be apparent to those of ordinary skill in the art that many more embodiments and implementations are possible that are within the scope of this invention.

What is claimed is:

1. A connection system comprising, in combination: at least one host device configured with at least a first portion of a connector application package, said at least one host device in communication with at least one client device configured with at least a second portion of said connector application package, said connector application package facilitating authorized access of media on said at least one host device by said at least one client device, wherein said media comprises at least one of media residing on said at least host device and additional media to be stored on said at least one host device.

2. The system of claim 1 further comprising at least one server, said at least a first portion of a connector application package of said at least one host device configured to maintain communication with said at least one server and to invite at least one identified client device configured with at least a second portion of said connector application package to connect to said at least one host device.

3. The system of claim 1 further comprising at least one server provisioned with at least identifying data associated with said at least one host device to protect and authorize communication between said at least one host device not addressable outside a local network and said at least one client device.

4. The system of claim 1, wherein said client device comprises at least one authorized client device configured to access and retrieve media content and at least one index of said media content and said at least one index on a host device.

5. The system of claim 1 further comprising at least one preference engine configured to track accessible media and to apply a weighting to said accessible media based on how often said accessible media is accessed.

6. The system of claim 1, wherein said at least one client device comprises a remote control in communication with at least one media player application, said remote control configured to instruct said at least one media player application to playback said media on at least one authorized host device.

7. The system of claim 4, wherein at least one client media player comprises at least one cache to allow local storage of host media and playback of media on said at least one client device to continue when communication between said at least one host device and said at least one client device is momentarily lost.

8. A personalized radio comprising, in combination: a client device configured with at least a first portion of a connector application package, at least one host device configured with at least a second portion of said connector application package and said at least one host device in communication with said client device, said connector application package facilitating authorized access of distributed media on said personalized radio comprising at least one of said at least one host device and said client device, wherein said distributed media comprises at least one of media residing on said at least host device and additional distributed media to be stored on said at least one host device or at least one server.

9. The radio of claim 8, wherein said distributed media including at least one of syndicated programming, news feeds, advertising content and other groups of media multi-path streamed to said personalized radio.

10. The radio of claim 8 further comprising at least one server configured to provide personalized media from at least one of the following: server hosted media including media available for purchase and media content from at least one host device.

11. The radio of claim 8, wherein said at least one server comprises at least one personalization engine configured to determine at least one user preferred media from a plurality of user preference profiles and to create dynamic playlists of media with a high probability of user acceptance.

12. A method of installing and implementing a connection system comprising the steps of:
providing at least one host device and at least one client device;
configuring said at least one host device with a first portion of a connector application package to create at least one user account data;
configuring said at least one client device with a second portion of said connector application package to thereby communicate with said at least one host device; and
facilitating authorized access of media with said connector application on said at least one host device by said at least one client device, wherein said media comprises at least one of media residing on said at least host device and additional media to be stored on said at least one host device.

13. The method of claim 12 further comprising the steps of:
storing said at least one user account data on at least one server; and
maintaining a connection between said at least one server and both said at least one host device and said at least one client device to permit accessibility of said media.

14. The method of claim 12 further comprising the step of: providing an outbound connection made by said at least one host device to at least one server thereby permitting said at least one host device to be addressable and accessible by at least one client device.

15. The method of claim 12 further comprising the steps of:
installing at least one host application on said at least one host device, said at least one host application having access to media accessible to said at least one host device; and
making said media accessible to at least one authorized client device with said at least one host application.

16. The method of claim 15 further comprising the step of: coupling said at least one host application to at least one pre-existing host application, said at least one host application having access to invoke functionality on said pre-existing host application.

17. The method of claim 15 wherein said at least one host application on said at least one host device being identified by a host device token, said host device token generated by either of said at least one host device or at least one server, said host device token stored on said at least one server to prevent unauthorized access to said at least one host device.

18. The method of claim 12 further comprising the steps of:
generating at least one client identifier corresponding to said at least one client device to configure said at least one client device with said second portion of said connector application package;
binding a communication connection of said at least one client device to a communication connection of said at least one host device; and
streaming media between said at least one host device and said at least one client device.

19. The method of claim 12 further comprising the steps of storing at least one client identifier corresponding to a client device and at least one host identifier corresponding to a host device on at least one server; and authorizing a communication connection with said at least one client identifier on said at least one server of said client device to a communication connection of said host device.
